(19) United States
(12) Patent Application Publication
(10) Pub. No.: US 2022/0082685 A1
(43) Pub. Date: Mar. 17, 2022

(54) SYSTEMS AND METHODS FOR ADAPTIVE WHISPER-SHOUT FOR ENHANCED DEGARBLE CAPABILITY

(71) Applicant: AVIATION COMMUNICATION & SURVEILLANCE SYSTEMS, LLC, Phoenix, AZ (US)

(72) Inventors: Mark Dean SMITH, Glendale, AZ (US); Gregory T. STAYTON, Peoria, AZ (US)

(21) Appl. No.: 17/473,523

(22) Filed: Sep. 13, 2021

Related U.S. Application Data
(60) Provisional application No. 63/077,051, filed on Sep. 11, 2020.

(51) Int. Cl. G01S 13/933; G08G 5/04; G01S 13/76; G01S 13/78

(52) U.S. Cl. CPC G01S 13/933; G01S 13/781; G01S 13/767; G08G 5/04

(57) ABSTRACT

An adaptive interrogation method is provided, the method including determining application of an adaptive whisper shout interrogation sequence. The determination may be predictive and based on an anticipation of garbled replies or may be reactive and based on a plurality of replies to an initial ATCRBS interrogation, there being interference between the replies such that the replies are unable to be properly decoded. The adaptive whisper shout interrogation sequence includes adapting a subsequent ATCRBS interrogation. The adaptation may be a change in an amplitude difference between an interrogation pulse and a suppression pulse of the subsequent ATCRBS interrogation (i.e. a bin width), as compared to the initial ATCRBS interrogation; or the adaptation may be a change in a power of the subsequent ATCRBS interrogation as compared to the initial ATCRBS interrogation. The subsequent ATCRBS interrogation is then transmitted, and one or more replies are received.

### CROSS-REFERENCE TO RELATED APPLICATION

This application claims the benefit of U.S. Provisional Application 63/077,051, filed Sep. 11, 2020 in the United State Patent Office, the disclosure of which is incorporated herein by reference in its entirety.

### BACKGROUND

### 1. Field

Apparatuses and methods consistent with exemplary embodiments relate to an interrogation method, and more particularly to an adaptive ATCRBS interrogation method.

### 2. Description of the Related Art

An existing Traffic Collision Avoidance System (TCAS), as described, for example, in the Radio Technical Commission for Aeronautics (RTCA) standard RTCA DO-185B—Minimum Operational Performance Standards for Traffic Alert and Collision Avoidance System II (TCAS II), version 7.1, volumes I and II, prepared by RTCA SC-147, 2008 (“RTCA DO-185B”), or TCAS I (see RTCA DO-197A, Minimum Operational Performance Standards for an Active Traffic Alert and Collision Avoidance System I (Active TCAS I), prepared by RTCA SC-147, 1994 (“RTCA DO-197A”)) may use a whisper shout interrogation sequence to partition the airspace so that only a few Air Traffic Control Radar Beacon System (ATCRBS) transponders reply to any single TCAS ATCRBS interrogation. Too many replies received simultaneously are likely to result in reply garble: an interference caused by multiple replies being received in an overlapped manner, such that one or more of the replies cannot be properly processed. One purpose of the Whisper-Shout interrogation sequence is to reduce reply garble.

A whisper shout attenuation function of a TCAS is intended to provide some selectivity as to which transponder-equipped aircraft respond to TCAS interrogations. The whisper shout attenuation changes the transmitted output power level from the TCAS. The TCAS interrogates close aircraft first, and increases its range incrementally in range rings about the aircraft. This is accomplished by sending out suppression pulses ahead of the interrogation that are slightly lower in amplitude than the interrogation. If the suppression pulses are high enough in amplitude to be detected by the intruder's transponder, the transponder doesn't reply to the TCAS interrogation. At each successive increase in power by decreasing the whisper shout attenuation, the transmission range increases and new aircraft are interrogated while previously-contacted aircraft cease to respond. This accomplishes a reduction in the number of RF replies in the environment to avoid excessive RF replies (known as RF pollution).

ATCRBS transponders may reply to interrogations received at or above their Minimum Trigger Level (MTL), where the term MTL describes the amplitude of the received interrogation at which the transponder has a 90% chance of decoding the interrogation. By changing the RF power level of a TCAS interrogation in discrete steps, with a suppression “S” pulse at a lower power level than the TCAS interrogation pulses, ATCRBS transponders will only begin responding when interrogation step levels begin to exceed the transponder's MTL, and will stop responding when the “S” pulse exceeds the transponder's MTL at higher interrogation power level steps. One simple ATCRBS interrogation is shown in the graph of FIG. 1, in which time is shown on the x-axis and pulse amplitude is shown on the y axis. The S1 pulse amplitude is lower than the P1 and P3 pulse amplitudes. In this figure the dashed line represents the transponder's MTL. As can be seen, only the P1 and P3 pulses are above the MTL, and the S1 pulse is not received, so the transponder will reply to this interrogation.

In contrast to the example of FIG. 1, in FIG. 2, in which time and pulse amplitude are also shown on the x- and y-axes, respectively, the S1, P1, and P3 pulse amplitudes are all greater than the transponder's MTL, and thus the transponder will be suppressed and will not reply.

In addition to using whisper shout techniques to reduce a number of replies received simultaneously, a directional antenna may allow interrogations to be primarily transmitted into a single quadrant, further reducing the likelihood of garble, by reducing the number of transponders that will receive the interrogation. The combination of the use of a directional antenna coupled with the use of whisper shout may be successfully utilized to allow operation in even the most dense airspace. Transponder replies are received by a TCAS system directional antenna. A TCAS directional antenna and associated TCAS system electronics and software may then use an amplitude or phase monopulse technique to measure the relative bearing from an own aircraft to other airborne vehicles' ATCRBS transponders. This method of transmitting with the directional antenna using the whisper shout technique effectively segments the airspace into quarter-ring slices as shown in FIG. 3, allowing a TCAS system to more efficiently process reply data with a reduced probability of garble.

However, there is a desire to further simplify existing systems to enable operation in a broader range of applications, including Unmanned Aerial Systems (UAS) and Urban Air Mobility (UAM). Many additional applications would benefit from a simpler system, reduced in size, weight, power, and cost (SWaP-C), that could achieve equivalent or similar performance.

Existing TCAS II systems have a number of disadvantages, including, but not limited to: a requirement for a directional antenna that adds to TCAS system cost; the additional weight of the directional antenna and the required multiple coaxial cables associated with directional antenna beams; the requirement for a separate receiver and hardware/software for each directional antenna beam to determine and process the strongest signal and process the airborne vehicles bearing for amplitude monopulse systems; the need for an adapter plate to many of existing smaller aircraft fuselages due to the size of the directional antenna; the use of a 1 dB power step in the whisper-shout algorithm resulting in a need for at least 24 whisper-shout steps and the use of multiple directional antenna beams to further divide up the RF airspace environment to prevent significant 1090 MHz transponder reply channel interference with ATCRBS transponders and newer transponder equipment such as Mode S transponders.

For at least these reasons, it would be desirable to enable use of an omnidirectional antenna to simplify a TCAS system.

### SUMMARY

Example embodiments may address at least the above problems and/or disadvantages and other disadvantages not described above. Also, example embodiments are not required to overcome the disadvantages described above, and may not overcome any of the problems described above.

One or more example embodiments may provide an adaptive interrogation method comprising: transmitting an initial ATCRBS interrogation; determining application of an adaptive whisper shout interrogation sequence; in response to the determining, adapting a subsequent ATCRBS interrogation by performing at least one of: changing an amplitude difference between an interrogation pulse and a suppression pulse of the subsequent ATCRBS interrogation as compared to a previous ATCRBS interrogation; and changing a power of the subsequent ATCRBS interrogation as compared to the initial ATCRBS interrogation; transmitting the adapted subsequent ATCRBS interrogation; and receiving one or more replies to the adapted subsequent ATCRBS interrogation.

The determining may comprise: receiving a plurality of replies to the initial ATCRBS interrogation; and determining that the plurality of replies result in garbling and an inability to decode one or more of the plurality of replies.

The determining may comprise: determining an overlap of 50 percent or more between two replies of the plurality of replies.

The determining may comprise anticipating garbling of a plurality of replies.

The changing the power of the subsequent ATCRBS interrogation may further comprise changing a range of power levels of the subsequent ATCRBS interrogation to omit a power level corresponding to a distance from which replies to the initial ATCRBS interrogation are not received.

According to an aspect of another example embodiment, a traffic collision avoidance system (TCAS) is provided comprising: an antenna, a transmitter; a receiver; a non-transitory memory; and a processor configured to execute instructions stored on the memory and thereby perform a method comprising: transmitting, by the transmitter, an initial ATCRBS interrogation; determining application of an adaptive whisper shout interrogation sequence; in response to the determining, adapting a subsequent ATCRBS interrogation by performing at least one of: changing an amplitude difference between an interrogation pulse and a suppression pulse of the subsequent ATCRBS interrogation as compared to a previous ATCRBS interrogation; and changing a power of the subsequent ATCRBS interrogation as compared to the initial ATCRBS interrogation; transmitting, by the transmitter, the adapted subsequent ATCRBS interrogation; and receiving, by the receiver, one or more replies to the adapted subsequent ATCRBS interrogation.

According to an aspect of another example embodiment, a non-transitory computer-readable storage medium is provided, having stored thereon instructions for performing a method comprising: controlling a transmitter of a traffic collision avoidance system (TCAS) to transmit an initial ATCRBS interrogation; determining application of an adaptive whisper shout interrogation sequence; in response to the determining, adapting a subsequent ATCRBS interrogation by performing at least one of: changing an amplitude difference between an interrogation pulse and a suppression pulse of the subsequent ATCRBS interrogation as compared to a previous ATCRBS interrogation; and changing a power of the subsequent ATCRBS interrogation as compared to the initial ATCRBS interrogation; controlling the transmitter of the TCAS to transmit the adapted subsequent ATCRBS interrogation; and controlling a receiver of the TCAS to receive one or more replies to the adapted subsequent ATCRBS interrogation.

### BRIEF DESCRIPTION OF THE DRAWINGS

The above and/or other aspects will become apparent and more readily appreciated from the following description of example embodiments, taken in conjunction with the accompanying drawings, in which:

FIG. 1 is a graph illustrating an ATCRBS interrogation in a suppression pulse—reply case;

FIG. 2 is a graph illustrating an ATCRBS interrogation in a suppression pulse—no reply case;

FIG. 3 illustrates a use of whisper shout in conjunction with a directional antenna to reduce garble;

FIG. 4 illustrates a use of whisper shout with an omnidirectional antenna according to an example embodiment;

FIG. 5 illustrates a reduced range ring according to an example embodiment;

FIG. 6 illustrates shifted range rings according to an example embodiment;

FIG. 7 is a block diagram of a TCAS transmitter and whisper shout attenuator according to related art;

FIG. 8 is a flow chart of a responsive, adaptive interrogation method according to an example embodiment; and

FIG. 9 is a flow chart of a predictive, adaptive interrogation method according to an example embodiment.

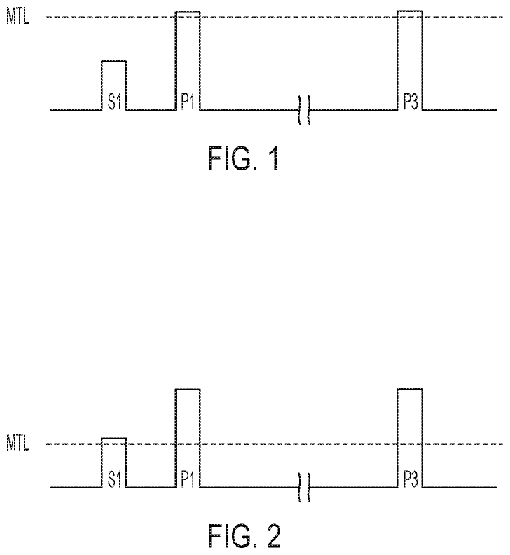

### DETAILED DESCRIPTION

Reference will now be made in detail to example embodiments which are illustrated in the accompanying drawings, wherein like reference numerals refer to like elements throughout. In this regard, the example embodiments may have different forms and may not be construed as being limited to the descriptions set forth herein.

It will be understood that the terms “include,” “including”, “comprise, and/or “comprising,” when used in this specification, specify the presence of stated features, integers, steps, operations, elements, and/or components, but do not preclude the presence or addition of one or more other features, integers, steps, operations, elements, components, and/or groups thereof.

It will be further understood that, although the terms “first,” “second,” “third,” etc., may be used herein to describe various elements, components, regions, layers and/or sections, these elements, components, regions, layers and/or sections may not be limited by these terms. These terms are only used to distinguish one element, component, region, layer or section from another element, component, region, layer or section.

As used herein, the term “and/or” includes any and all combinations of one or more of the associated listed items. Expressions such as “at least one of,” when preceding a list of elements, modify the entire list of elements and do not modify the individual elements of the list.

Various terms are used to refer to particular system components. Different companies may refer to a component by different names—this document does not intend to distinguish between components that differ in name but not function.

Matters of these example embodiments that are obvious to those of ordinary skill in the technical field to which these exemplary embodiments pertain may not be described here in detail.

According to an example embodiment, an omnidirectional antenna may be used in place of a directional antenna for transmitting interrogations and receiving ATCRBS and Mode S transponder replies. Bearing may be determined for each transponder using ADS-B squitters that already provide an airplane's latitude and longitude enabling an own aircraft to determine a relative bearing to any ADS-B equipped aircraft. A number of aircraft that must be continuously interrogated may be reduced.

Referring to FIG. 4, it can be seen that the use of an omnidirectional antenna may reduce or eliminate the ability of the interrogating system to partition an airspace into quadrants as shown, because the transmission is in all directions with approximately equal power. FIG. 4 illustrates an example of two intruder aircraft being at similar ranges in different quadrants. According to this example, both intruder aircraft will reply to the same omnidirectional whisper shout interrogation, and their replies may be garbled.

The omnidirectional interrogation of ATCRBS intruders may be used in conjunction with a new whisper-shout interrogation algorithm to compensate for the increased interference due to the loss of directionality. For this method to be approved by the Federal Aviation Administration (FAA), it must be capable of providing performance levels similar to those of the systems using at least one directional antenna in such metrics as track probability and surveillance range. One or more example embodiments described herein may provide such an improvement.

Existing whisper shout algorithms may allow the TCAS system to select between a high resolution sequence, for dense airspace, and a minimum basic sequence that greatly reduces the number of interrogations in low density airspace. These are fixed sequences with little flexibility to adapt to the current airspace environment. It would be advantageous to have an ability to tailor the whisper shout sequence to optimize an algorithm for a given set of intruders in the airspace. This ability to adapt the whisper shout sequence would enable the system to segregate previously-garbled replies or replies which are anticipated to become garbled due to a predicted scenario. According to one or more example embodiments, certain means of optimization and adaptation may include one or more of changing a bin size (the amplitude difference between the suppression pulse and the interrogation pulses) of an interrogation, adjusting the power level of an interrogation, and injecting an additional power level interrogation in order to gain better partitioning of the airspace being surveilled, or eliminating steps that have not received replies.

This concept of an adaptable or flexible whisper shout algorithm will be referred to herein as “adaptive whisper shout”. Related art standards may allow for alternate whisper shout algorithms, but a new set of industry performance standards may be developed for an omnidirectional TCAS, rather than employing deviations against existing TCAS standards. Modern transmitters are very capable of precisely controlling an output power level, making it possible to implement flexible step sizes and variable power levels which are useful for garble reduction by use of an adaptive whisper shout algorithm described herein.

Referring again to FIG. 4, the shaded circle represents a range ring in which intruders are expected to reply to a standard ATCRBS interrogation. The radial axis represents a distance from an own aircraft. In this example, both aircraft may reply to the same interrogation, depending on their respective receiver MTL settings, antenna gain, and other aircraft dependent parameters such as bank angle. The degarbling capability of the existing TCAS may successfully degarble two garbled replies. However when three garbled replies are received, the probability of successfully decoding using an existing TCAS, is greatly reduced. For ease of explanation, example embodiments described herein will refer to two intruders. It should be understood, however, that the systems and methods described herein are equally applicable to three or more intruders. For ease of explanation take the length of an ATCRBS reply as 20.75 microseconds (μs), by way of example. Rounding the speed of light in free space to 1 ft/ns shows that if a difference in the distance to two aircraft is (20.75 μs)*(1000 ns/μs)*(1 ft/ns)/2 (round trip)=10,375 ft or approximately 1.71 nautical miles, there is a potential for overlapping replies, depending on the performance of the respective installed units. In practical terms, three intruders within that range and all replying may show a degradation in degarbling capability.

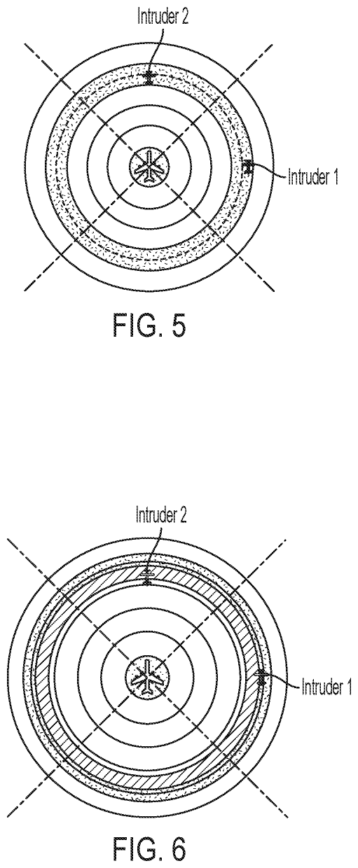

Given the garbled replies shown in FIG. 4, one response, according to an example embodiment, is to further divide the range ring in an attempt to prevent one of the intruders from replying at the same time as another. This is shown in FIG. 5 as the white dashed line in the middle of the shaded ring. This may be accomplished by reducing the bin size or the difference between the S1 pulse and the P1/P3 pulses. Closely examining FIG. 5, it can be seen that intruder 2 is on the inner portion of the subdivided range ring while intruder 1 is on the outer portion. These two subdivided range rings represent two separate interrogations, and the two intruders are thus more likely to reply to one and not the other, thereby improving the probability of a successful decoding of the replies. In a more practical case of three or four garbled intruders, even if the number of garbled intruders can be reduced to just two garbled intruders, the probability of successful decoding may be increased.

According to another example embodiment, the degarbling capability may be improved by shifting the range ring as is shown in FIG. 6. Given the same two example intruders, an increase or decrease in a power of the entire interrogation will change the amplitude relative to the MTL of the transponder, and improve the probability that one of the transponders may not reply to that interrogation. Alternately, an additional whisper-shout step may be inserted with a different intermediate radio frequency (RF) power, intermediate meaning greater than the lower level but less than the higher level. These methods may help achieve better airspace partitioning.

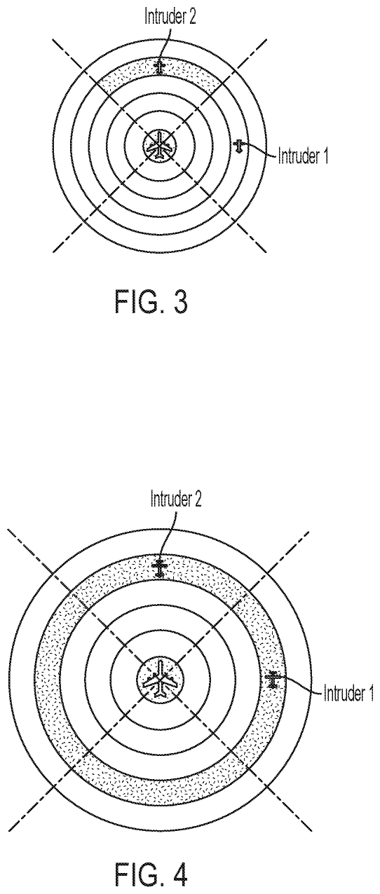

For purposes of ease of explanation, FIGS. 3-6 show one range ring ending where the next one starts. However in actual operation, there may often be an overlap of the range rings to increase the probability that all aircraft will reply at least once. A penalty for overlapping range rings may be that some aircraft may reply to multiple interrogations.

The term “adaptive whisper shout,” as used with respect to example embodiments described herein, applies one of more of the variables of reduced range ring sizes, additional whisper shout steps, and shifted range rings to improve an ability to reduce the number of garbled replies. These techniques can be used individually or in conjunction with one another to optimize improvements. However, the interrogation sequence is generally subject to interference limiting requirements, which are discussed, for example in RTCA DO-185B. Adaptive whisper shout can be used as a responsive or predictive method, meaning that the adaptation can be used following the reception of garbled replies, as in a responsive method, or it can be used when garbling is anticipated to occur, as in a predictive method. For example the predictive method may be used when multiple tracked aircraft appear to be approaching a same distance from an own aircraft, such that the replies are likely to overlap, and it is likely that garble may occur, assuming that the transponders all continue to reply. The reduced range ring resolution can be used to “zoom” in on particular sets of intruders. Additionally, since interrogation power may be controlled in order to satisfy interference limiting, interrogation power levels at certain ranges that are not being utilized for tracking can be temporarily eliminated in order to provide available power for additional interrogations at power levels where multiple garbled replies have been received. This is effectively a “power trade.” Accordingly, this power trade may be effected by not transmitting an interrogation at certain power levels corresponding to a distance from the own aircraft from which replies have not or are not being received, or by enlarging the bin size such that the range ring size is increased, effectively combining a plurality of steps into one.

The previous figures show example embodiments for ease in understanding by providing a visual example. The tables below demonstrate these concepts using example whisper shout sequences and showing interrogation power level and suppression pulse level. In Table 1, an example sequence is chosen that uses 12 steps with a standard bin size of 3 dB and a step size of 2 dB. Of course, the number of steps and bin size may be optimized for a particular application by either increasing or decreasing the number of steps or bin size. Table 1 is provided as a baseline that the following tables build upon. As an example, assume that multiple intruder replies were garbled on the 42 dBm interrogation amplitude step, shown outlined in bold in Table 1. In this example, it is assumed that the MTL of one of the garbled intruders is equivalent to a power received at the intruder from a 39.1 dBm interrogation. In other words, the intruder would reply to any interrogation with interrogation amplitude greater than 39.1 dBm, but with a suppression amplitude less than 39.1 dBm which includes both step 7 and step 8 of Table 1. Also, for this example, it is assumed that a second of the garbled intruders, whose MTL is equivalent to a power received at the intruder from a 39.9 dBm interrogation, and which would reply in a similar fashion to intruder 1. Table 1 includes columns showing whether or not intruders 1 and 2 would reply to the interrogation on that row. As can be seen, both intruders will reply to both step 7 and step 8, resulting in potential garble. One or more example embodiments described herein may offer multiple methods for refining the resolution of the whisper shout sequence in order to allow for a higher probability of ungarbled reception.

TABLE 1
Example Omnidirectional Whisper-Shout Sequence

| | | | | Intruder 1 | Intruder 2 |
|---|---|---|---|---|---|
| | Suppression | Interrogation | | reply? | reply? |
| Step | Amplitude | Amplitude | Bin | (MTL = | (MTL = |
| Number | (dBm) | (dBm) | Size | 39.1 dBm) | 39.9 dBm) |
| 12 | N/A | 32 | N/A | N | N |
| 11 | 31 | 34 | 3 | N | N |
| 10 | 33 | 36 | 3 | N | N |
| 9 | 35 | 38 | 3 | N | N |
| 8 | 37 | 40 | 3 | Y | Y |
| 7 | 39 | 42 | 3 | Y | Y |
| 6 | 41 | 44 | 3 | N | N |
| 5 | 43 | 46 | 3 | N | N |
| 4 | 45 | 48 | 3 | N | N |
| 3 | 47 | 50 | 3 | N | N |
| 2 | 49 | 52 | 3 | N | N |
| 1 | 51 | 54 | 3 | N | N |

According to one example embodiment, a response to garbling may be to split the range ring. This is shown in tabular form in Table 2 in the rows outlined in bold. Here, it can be seen that the interrogation amplitude of step 7 has changed, and an interrogation has been added as step 7a with yet a different interrogation amplitude. Further, the bin sizes of steps 7 and 7a have been reduced to half of the original value of step 7. Multiple options exist for how to assign the new suppression amplitude and interrogation amplitude. For example, the interrogation amplitudes of the revised and added steps could be evenly spaced between existing steps. Then the bin size can determine the suppression amplitude. Alternately, the suppression amplitude of the revised and added steps could be evenly spaced between existing steps. Then the bin size can determine the interrogation amplitude. For the example shown, the suppression amplitude will be evenly spaced. Table 2 shows that in this example, the intruder will only reply to step 8, because for both steps 7 and 7a, the intruder will be suppressed (the suppression pulse is above the intruder's MTL). This will leave step 7 and 7a free from the garble previously introduced by the intruder.

TABLE 2
Omnidirectional Whisper-Shout Sequence with Split Range Rings

| | | | | Intruder 1 | Intruder 2 |
|---|---|---|---|---|---|
| | Suppression | Interrogation | | reply? | reply? |
| Step | Amplitude | Amplitude | Bin | (MTL = | (MTL = |
| Number | (dBm) | (dBm) | Size | 39.1 dBm) | 39.9 dBm) |
| 12 | N/A | 32 | N/A | N | N |
| 11 | 31 | 34 | 3 | N | N |
| 10 | 33 | 36 | 3 | N | N |
| 9 | 35 | 38 | 3 | N | N |
| 8 | 37 | 40 | 3 | Y | Y |
| 7a | 38.33 | 39.83 | 1.5 | Y | N |
| 7 | 39.66 | 41.16 | 1.5 | N | Y |
| 6 | 41 | 44 | 3 | N | N |
| 5 | 43 | 46 | 3 | N | N |
| 4 | 45 | 48 | 3 | N | N |
| 3 | 47 | 50 | 3 | N | N |
| 2 | 49 | 52 | 3 | N | N |
| 1 | 51 | 54 | 3 | N | N |

According to another example embodiment, a response to garbling may be to shift the range ring which is demonstrated by increasing or decreasing the power of an interrogation. One option is to increase the power for a whisper-shout sequence and then reassess the replies for garble. On a next whisper-shout sequence, the power could be decreased in another attempt to decrease garble. Table 3 shows an example of increasing the interrogation amplitude by 0.5 dB for step 7, shown outlined in bold. This example may resolve garble that is occurring on step 7 due the same intruders replying simultaneously. With this shift in interrogation amplitude, both intruders will still reply to the interrogation of step 8, but intruder 1 will be suppressed for the interrogation of step 7, effectively removing the garble previously present.

TABLE 2
Omnidirectional Whisper-Shout Sequence with Shifted Range Ring

| | | | | Intruder 1 | Intruder 2 |
|---|---|---|---|---|---|
| | Suppression | Interrogation | | reply? | reply? |
| Step | Amplitude | Amplitude | Bin | (MTL = | (MTL = |
| Number | (dBm) | (dBm) | Size | 39.1 dBm) | 39.9 dBm) |
| 12 | N/A | 32 | N/A | N | N |
| 11 | 31 | 34 | 3 | N | N |
| 10 | 33 | 36 | 3 | N | N |
| 9 | 35 | 38 | 3 | N | N |
| 8 | 37 | 40 | 3 | Y | Y |
| 7 | 39.5 | 42.5 | 3 | N | Y |
| 6 | 41 | 44 | 3 | N | N |
| 5 | 43 | 46 | 3 | N | N |
| 4 | 45 | 48 | 3 | N | N |
| 3 | 47 | 50 | 3 | N | N |
| 2 | 49 | 52 | 3 | N | N |
| 1 | 51 | 54 | 3 | N | N |

According to an example embodiment, a responsive adaptive whisper shout method may be triggered by a trigger, within the TCAS. The trigger may, for example, indicate that a plurality of replies have resulted in garbling and an inability to decode one or more of the replies. This may be due to an overlap of more than three replies, an overlap of more than 50% between two replies, and/or another indication that the degarbler cannot adequately differentiate received responses. The trigger causes a next interrogation to be transmitted with a different bin size and/or a different number of amplitude steps.

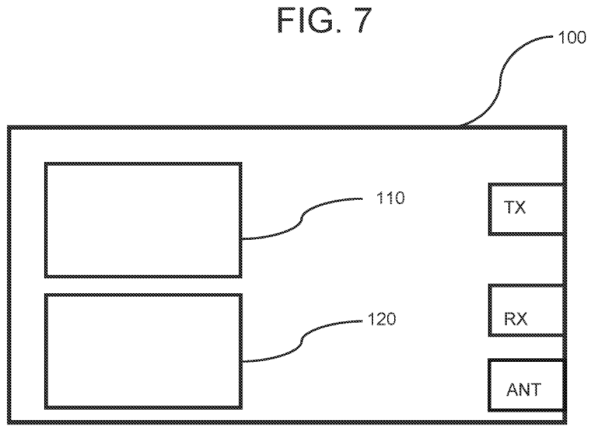

FIG. 7 shows a block diagram of one example embodiment of a TCAS unit 100, consistent with example methods described herein. TCAS unit 100 may include digital control circuitry and various gain controllers, inputs, amplifiers, power combiners, splitters, couplers, antennas, attenuators, and outputs. The control circuitry may include firmware, software stored in a non-transitory memory, and one or more processors, such as a software processor, and one or more field-programmable gate arrays (FPGAs). For example, the control circuitry may include a non-transitory memory 110 and a processor 120. The TCAS unit 100 may further include a transmitter TX, a receiver RX, and an antenna ANT.

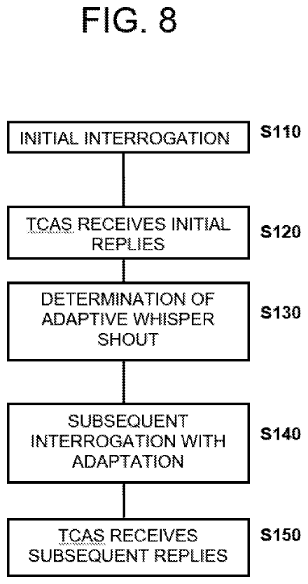

According to an example embodiment, a responsive, adaptive whisper shout method is shown in FIG. 8. An initial interrogation is transmitted from a TCAS via an omnidirectional antenna (S110). The TCAS receives a plurality of replies to the initial interrogation (S120). Based on the received plurality of replies resulting in garbled responses and the inability to properly decode one or more of the replies, and due to an overlap of more than 50% between two pulses of the plurality of replies or due to the plurality of replies being three or more, or another source of garble, a determination is made that an adaptive whisper shout method should be applied (S130). As noted, the determination may be made based on an amount of overlap between or among received pulses, and/or a number of pulses received. Based on the determination, a subsequent interrogation is transmitted with an adaptation (S140). The adaptation may be one or more of a change in bin size and a change in a number and/or spacing of amplitude steps. For example, the adaptation may be a reduction of the bin size of the subsequent interrogation or an increase or decrease in a transmission power of the subsequent interrogation, as compared to the initial interrogation. A reduction of the bin size of the subsequent interrogation may be obtained by evenly spacing interrogation amplitudes of additional steps, and thereby determining a corresponding suppression amplitude, or by evenly spacing suppression amplitudes of additional steps and thereby determining a corresponding interrogation amplitude. The TCAS may then then receive one or more replies to the subsequent interrogation (S150).

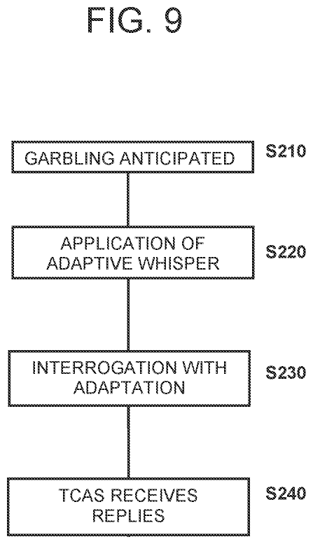

According to an example embodiment, a predictive, adaptive whisper shout method is shown in FIG. 9. It is anticipated that garbling will occur (S210), triggering application of an adaptive whisper shout method (S220). An adaptive whisper shout method (S230-S240), analogous to that of S140-S150 of FIG. 8 is performed.

Example embodiments described herein may demonstrate some advantages of an adaptive Whisper-Shout algorithm. Operations of dynamically changing a bin size, step size, or interrogation amplitude, or inserting steps or rearranging whisper-shout steps using any combination of these variables may be used to more efficiently partition the airspace to reduce the probability of garbled replies. Furthermore, example embodiments described herein may be used reactively, for better de-garbling of previously garbled replies, and/or proactively, for prevention of potentially garbled replies predicted to occur. One or more example embodiments may achieve improvements in track probability and surveillance range, even without the use of a directional antenna.

It may be understood that example embodiments described herein may be considered in a descriptive sense only and not for purposes of limitation. Descriptions of features or aspects within each example embodiment may be considered as available for other similar features or aspects in other example embodiments.

While example embodiments have been described with reference to the figures, it will be understood by those of ordinary skill in the art that various changes in form and details may be made therein without departing from the spirit and scope as defined by the following claims.

What is claimed is:

1. An adaptive interrogation method comprising:
transmitting an initial ATCRBS interrogation;
determining application of an adaptive whisper shout interrogation sequence;
in response to the determining, adapting a subsequent ATCRBS interrogation by performing at least one of:
changing an amplitude difference between an interrogation pulse and a suppression pulse of the subsequent ATCRBS interrogation as compared to a previous ATCRBS interrogation; and
changing a power of the subsequent ATCRBS interrogation as compared to the initial ATCRBS interrogation; and
transmitting the adapted subsequent ATCRBS interrogation.

2. The adaptive interrogation method according to claim 1, wherein the determining comprises:
receiving a plurality of replies to the initial ATCRBS interrogation; and
determining that the plurality of replies result in garbling and an inability to decode one or more of the plurality of replies.

3. The adaptive interrogation method according to claim 2, wherein the determining comprises:
determining an overlap of 50 percent or more between two replies of the plurality of replies.

4. The adaptive interrogation method according to claim 1, wherein the determining comprises anticipating garbling of a plurality of replies.

5. The adaptive interrogation method according to claim 1, wherein the changing the power of the subsequent ATCRBS interrogation comprises changing a range of power levels of a subsequent ATCRBS interrogation sequence by at least one of:
omitting a power level corresponding to a distance from which replies to the initial ATCRBS interrogation are not received, and
combining a plurality of steps into one interrogation.

6. A traffic collision avoidance system (TCAS) comprising:
a transmitter;
a receiver;
a non-transitory memory; and
a processor configured to execute instructions stored on the memory and thereby perform a method comprising:
transmitting, by the transmitter, an initial ATCRBS interrogation;
determining application of an adaptive whisper shout interrogation sequence;
in response to the determining, adapting a subsequent ATCRBS interrogation by performing at least one of:
changing an amplitude difference between an interrogation pulse and a suppression pulse of the subsequent ATCRBS interrogation as compared to a previous ATCRBS interrogation; and
changing a power of the subsequent ATCRBS interrogation as compared to the initial ATCRBS interrogation; and
transmitting, by the transmitter, the adapted subsequent ATCRBS interrogation.

7. The TCAS according to claim 6, wherein the determining comprises:
receiving, by the receiver, a plurality of replies to the initial ATCRBS interrogation; and
determining that the plurality of replies result in garbling and an inability to decode one or more of the plurality of replies.

8. The TCAS according to claim 7, wherein the determining comprises:
determining an overlap of 50 percent or more between two replies of the plurality of replies.

9. The TCAS according to claim 6, wherein the determining comprises anticipating garbling of a plurality of replies.

10. The TCAS according to claim 6, wherein the changing the power of the subsequent ATCRBS interrogation comprises changing a range of power levels of a subsequent ATCRBS interrogation sequence by at least one of:
omitting a power level corresponding to a distance from which replies to the initial ATCRBS interrogation are not received, and
combining a plurality of steps into one interrogation.

11. A non-transitory computer-readable storage medium having stored thereon instructions for performing a method comprising:
controlling a transmitter of a traffic collision avoidance system (TCAS) to transmit an initial ATCRBS interrogation;
determining application of an adaptive whisper shout interrogation sequence;
in response to the determining, adapting a subsequent ATCRBS interrogation by performing at least one of:
changing an amplitude difference between an interrogation pulse and a suppression pulse of the subsequent ATCRBS interrogation as compared to a previous ATCRBS interrogation; and
changing a power of the subsequent ATCRBS interrogation as compared to the initial ATCRBS interrogation;
controlling the transmitter of the TCAS to transmit the adapted subsequent ATCRBS interrogation.

12. The non-transitory computer-readable storage medium according to claim 11, wherein the determining comprises:
controlling the receiver of the TCAS to receive a plurality of replies to the initial ATCRBS interrogation; and
determining that the plurality of replies result in garbling and an inability to decode one or more of the plurality of replies.

13. The non-transitory computer-readable storage medium according to claim 12, wherein the determining comprises:
determining an overlap of 50 percent or more between two replies of the plurality of replies.

14. The non-transitory computer-readable storage medium according to claim 11, wherein the determining comprises anticipating garbling of a plurality of replies.

15. The non-transitory computer-readable storage medium according to claim 11, wherein the changing the power of the subsequent ATCRBS interrogation comprises changing a range of power levels of a subsequent ATCRBS interrogation sequence by at least one of:
omitting a power level corresponding to a distance from which replies to the initial ATCRBS interrogation are not received, and
combining a plurality of steps into one interrogation.
